(19) United States
(12) Patent Application Publication
(10) Pub. No.: US 2024/0206383 A1
(43) Pub. Date: Jun. 27, 2024

(54) Mower and Work Machine Equipped With Mower

(71) Applicant: Kubota Corporation, Osaka-shi (JP)

(72) Inventor: Masahiro Yamada, Osaka (JP)

(21) Appl. No.: 18/387,096

(22) Filed: Nov. 6, 2023

(30) Foreign Application Priority Data
Dec. 23, 2022 (JP) 2022-206987

(51) Int. Cl. A01D 34/66; A01D 34/73; A01D 34/78; A01D 34/81; A01D 34/82

(52) U.S. Cl. CPC A01D 34/66; A01D 34/73; A01D 34/78; A01D 34/81; A01D 34/826; A01D 2101/00

(57) ABSTRACT

A mower mounted to a travel machine body includes a mower deck that is open downward and at least one rotary cutter located inside the mower deck and configured to rotate about a vertical axis, the at least one rotary cutter being a string-like resin member.

### CROSS-REFERENCE TO RELATED APPLICATION

This application claims priority to Japanese Patent Application No. 2022-206987 filed Dec. 23, 2022, the disclosure of which is hereby incorporated by reference in its entirety.

### BACKGROUND OF THE INVENTION

### 1. Field of the Invention

The present invention relates to a mower and a work machine equipped with a mower.

### 2. Description of Related Art

Mowers are mounted to ride-on travel machine bodies and used for mowing work. Travel machine bodies are often driven by an engine, and the mowers are also rotationally driven by the motive power of the engine. Conventionally, such mowers are designed to cut grass that has been planted, due to metal blades that rotate about a vertical axis rotating at high speed about the vertical axis (e.g., see JP 2009-165366A).

### SUMMARY OF THE INVENTION

Recently, work machines in which the travel machine body is driven using an electric motor or the like instead of an engine have been proposed in consideration of environmental degradation. With such electric work machines, noise generated by the travel machine body is kept low.

However, an unfavorable aspect of mowers that rotate metal blades at high speed as in the above conventional configuration is the loud noise due to wind noise generated by the metal blades rotating at high speed during mowing work. Another disadvantage is the large driving force required, which leads to increased energy consumption arising from factors such as the increased size of the driving device.

In view of this, there is demand for a mower capable of performing mowing work with low noise while suppressing energy consumption, and a work machine equipped with such a mower.

A mower mountable to a travel machine body, comprising:

a mower deck open downward; and

at least one rotary cutter located inside the mower deck and configured to rotate about a vertical axis, wherein:

the at least one rotary cutter is a string-like resin member.

According to the above configuration, the rotary cutter of the mower is constituted by a string-like resin member, and thus a loud wind noise is not generated even at high rotation speeds, allowing noise to be kept low. Furthermore, the rotary cutter is lightweight, thus enabling energy consumption when the rotary cutter is rotationally driven to also be kept low. As a result, in the case of an electric drive mower, for example, a compact electric motor can be used, and it is also possible to extend the operating time due to the low power consumption.

Accordingly, it become possible to provide a mower capable of performing mowing work with low noise while suppressing energy consumption.

In the above configuration, preferably the at least one rotary cutter includes a plurality of rotary cutters spaced apart from each other inside the mower deck, the mower deck includes a top plate covering an upper portion thereof; and a peripheral wall extending down along a peripheral edge of the top plate, and the peripheral wall includes a back peripheral wall located on a back side thereof and having a wavy shape extending along rotation loci of outer edges of the rotary cutters.

According to this configuration, a plurality of rotary cutters are provided, thus expanding the work width that can be mowed at one time, and improving work efficiency. In addition, the back peripheral wall is formed in a wavy shape that extends along the rotation loci of the outer edges of the rotary cutters, thus enabling favorable mowing due to avoiding a situation in which grass that is subjected to the cutting action by the rotary cutters escapes radially outward and cannot be cut.

In the above configuration, preferably the at least one rotary cutter has a curved portion. Also, preferably the curved portion protrudes downstream in a rotation direction of the at least one rotary cutter.

A work machine comprising:

a travel machine body;

a travel device;

a mower mounted to the travel machine body, including:
a mower deck open downward; and
at least one rotary cutter located inside the mower deck and configured to rotate about a vertical axis;

a travel electric motor configured to drive the travel device; and

a work electric motor configured to rotationally drive the at least one rotary cutter, wherein:

the at least one rotary cutter is a string-like resin member.

According to this configuration, the travel device is driven by a travel electric motor, thus avoiding loud noises being generated as the machine body travels, compared with the case where the travel device is driven by an engine, for example. Also, the rotary cutter is driven by a work electric motor, thus avoiding loud drive noises being generated when the rotary cutter is rotationally driven at high speed.

As a result, loud drive noises are not generated in the travel drive of the machine body or the rotational drive of the rotary cutter in the mower, in addition to loud noises not generating from the rotary cutter rotating at high speed in order to cut grass, thus enabling a work machine capable of suppressing generation of loud noises as a whole to be provided.

### BRIEF DESCRIPTION OF THE DRAWINGS

FIG. 1 is an overall side view of a work machine.

FIG. 2 is a transverse sectional plan view of a mower.

FIG. 3 is a plan view of the mower.

FIG. 4 is a plan view of a mower of another embodiment.

FIG. 5 is a plan view of a mower of another embodiment.

### DESCRIPTION OF THE INVENTION

Modes for carrying out the invention will be described based on the drawings. Note that, in the following description, unless otherwise specified, the direction of arrow F and the direction of arrow B in the diagrams are respectively “front” and “back”, and the direction of arrow U and the direction of arrow D in the diagrams are respectively “up” and “down”.

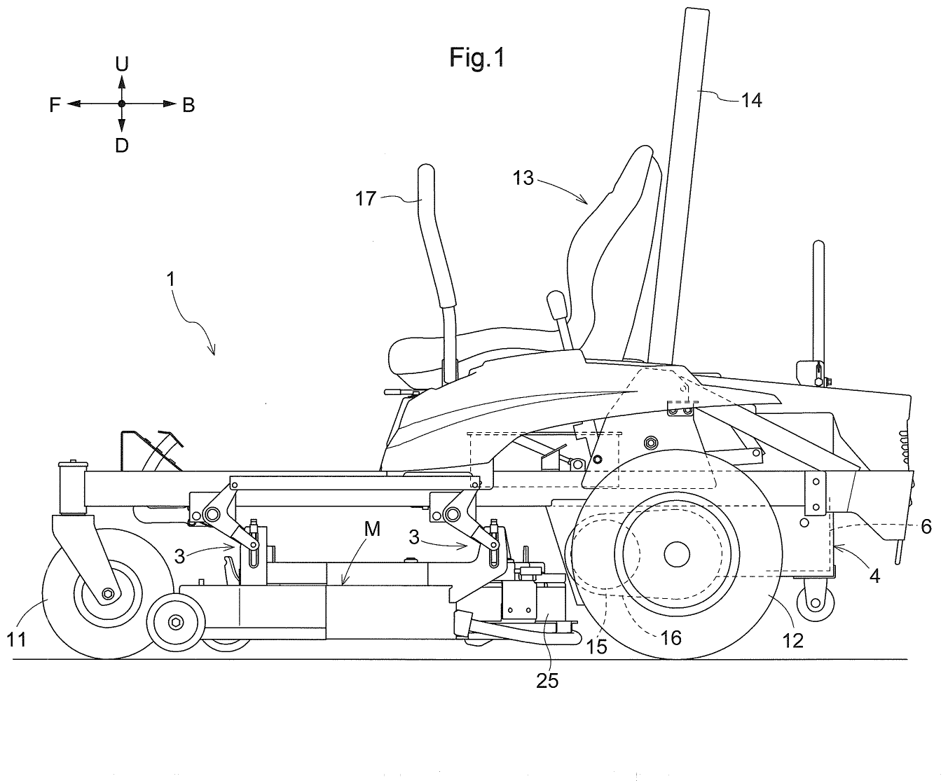

FIG. 1 shows a work machine equipped with a motor according to the invention.

The work machine is provided with a travel machine body 1 including a pair of left and right front wheels 11 supported in a front portion and a pair of left and right back wheels 12 serving as a travel device 2 supported in a back portion. In addition, between the front wheels 11 and the back wheels 12 is mounted a mower M in a lower portion of the travel machine body 1. The mower M is supported in a suspended manner by the vehicle body via a link mechanism 3 of a quadruple link structure.

Between the left and right back wheels 12 is provided a battery housing section 4 for housing a battery 6. Furthermore, the travel machine body 1 includes a driver's seat 13 and a ROPS frame 14.

This work machine is an electric drive mowing work machine.

The front wheels 11 are caster-type wheels, and the back wheels 12 are drive wheels. On the inner side of the back wheels 12 are respectively disposed a pair of left and right travel electric motors (hereinafter, travel motors) 15. The motive power of the travel motors 15 is transmitted to the back wheels 12 via a speed reducer 16. Each back wheel 12 is independently driven.

On left and right sides of the driver's seat 13 are respectively disposed left and right shift levers 17. The left and right travel motors 15 are driven and controlled by a control device (not shown), based on operation of the left and right shift levers 17. That is, when the right shift lever 17 is operated to a neutral position, the right travel motor 15 stops. When the right shift lever 17 is operated to the forward side, the right travel motor 15 rotates to the forward side, and when the right shift lever 17 is operated to the reverse side, the right travel motor 15 rotates to the reverse side. Similarly, when the left shift lever 17 is operated to the neutral position, the forward side or the reverse side, the left travel motor 15 performs similar operations to the right travel motor 15 described above. In other words, by operating the right and left shift levers 17, the right and left back wheels 12 are driven to the forward side or the reverse side independently to each other, and the travel machine body 1 moves forward or back, or turns right or left. The operating state of the left and right shift levers is detected by a potentiometer (not shown) and input to the control device.

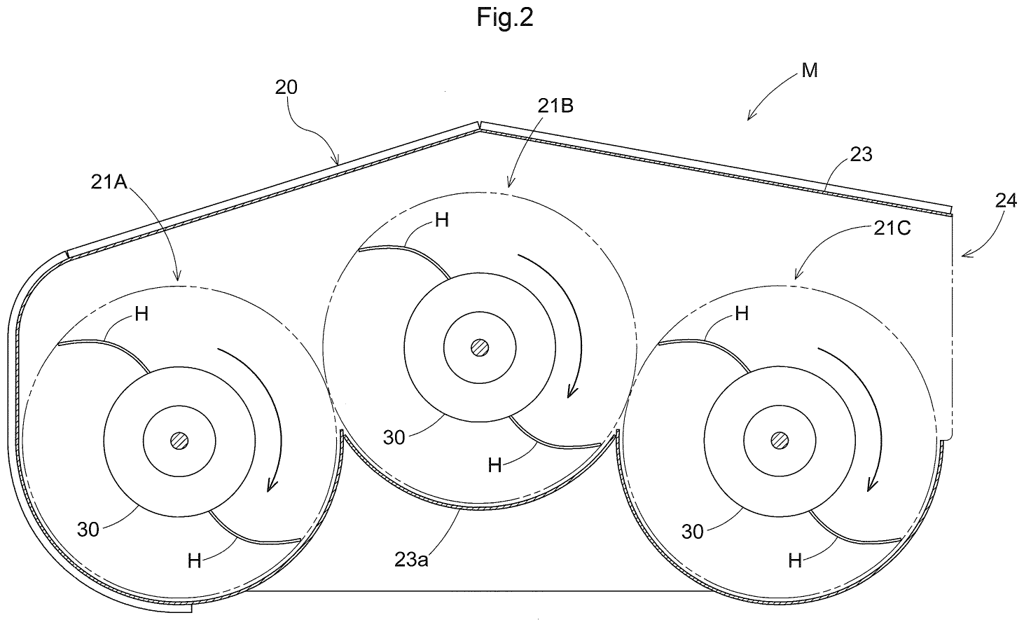

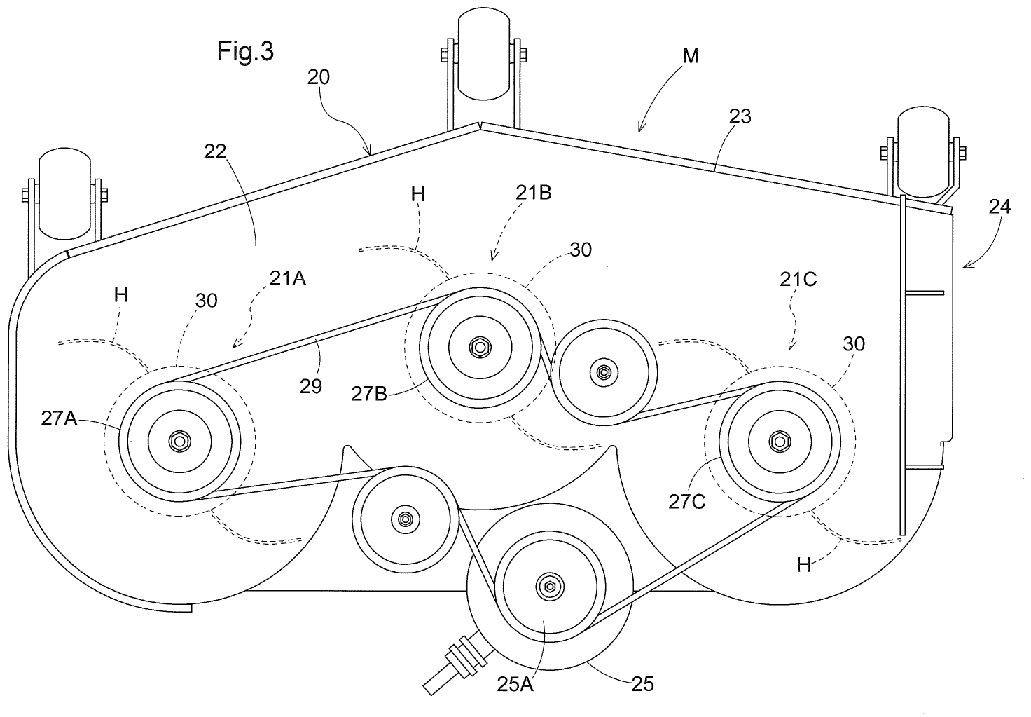

As shown in FIGS. 2 and 3, the mower M has a mower deck 20 that is open downward, and inside the mower deck 20 are three rotary cutters 21A, 21B and 21C that are each rotationally driven about a vertical axis, and axially supported in a triangular arrangement in plan view such that the middle rotary cutter 21B is displaced slightly forward. When the travel machine body 1 moves in a straight ahead, lateral edges of the rotation loci of the tips of the adjacent rotary cutters 21A, 21B and 21C thereby overlap longitudinally to enable favorable mowing without leaving any unmown regions.

The mower deck 20 has a top plate 22 covering an upper portion thereof and a peripheral wall 23 extending down along the peripheral edge of the top plate 22. The mower deck 20 is a flat deck whose top plate height is the same throughout, and in a right edge portion of the mower deck 20 is formed a discharge opening 24.

On the back side of the peripheral wall 23 of the mower deck 20 is a back peripheral wall 23a having a wavy shape that extends along the rotation loci of the tips of the rotary cutters 21A, 21B and 21C. The mower deck 20 has a series of cutting spaces that are laterally long and communicate with each other in which the rotary cutters 21A, 21B and 21C are respectively disposed.

The rotary cutters 21A, 21B and 21C are rotationally driven by a work electric motor 25 (hereinafter, a work motor). The work motor 25 is located on the back side of the mower M and is supported by the mower deck 20.

As shown in FIG. 3, the motive power of the work motor 25 is transmitted to each of the rotary cutters 21A, 21B and 21C via a transmission belt 29 disposed in an upper portion of the mower deck 20. That is, the transmission belt 29 is wound around an output pulley 25A provided in the work motor 25 and pulleys 27A, 27B and 27C respectively provided in the rotary cutters 21A, 21B and 21C, and the rotary cutters 21A, 21B and 21C are rotationally driven in the same direction (clockwise in top view) at uniform speed.

As shown in FIG. 2, the rotary cutters 21A, 21B and 21C are each a string-like resin member. Specifically, the rotary cutters 21A, 21B and 21C are each constituted by a string-like member H made of a nylon material. On the radial inner side of each of the rotary cutters 21A, 21B and 21C is provided a substantially cylindrical drum member 30 that holds the string-like member H in a wound state, and the string-like member H extends radially outward from the drum member 30 in a cantilever manner. Two string-like members H are spaced approximately 180 degrees apart from each other in the circumferential direction.

The string-like members H are housed in a wound state inside the drum member 30, this being a known configuration and thus not shown. Inside the drum member 30 is provided a feeding mechanism (not shown) capable of feeding out the string-like members H by a predetermined amount each time. The feeding mechanism is able to automatically feed the string-like members H radially outward, when the string-like members H become worn as a result of mowing work.

Due to the rotary cutters 21A, 21B and 21C being rotationally driven at high speed, the string-like members H exhibit a cutting action on grass that has been planted, enabling the grass to be favorably cut. The mown grass clippings can be transferred to the discharge opening 24 by the rotational force of the rotary cutters 21A, 21B and 21C and discharged out of the mower deck.

### OTHER EMBODIMENTS

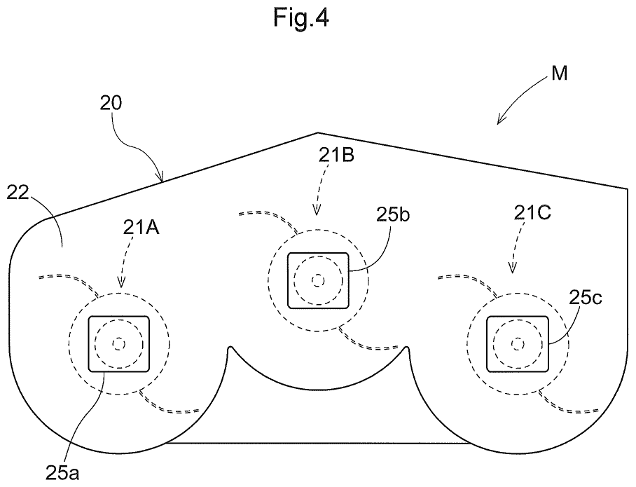

(1) In the above embodiment, only one work motor 25 is provided, and the three rotary cutters 21A, 21B and 21C are driven by the one work motor 25. Alternatively, as shown in FIG. 4, three motors 25a, 25b and 25c may be provided as the work motor 25, and the three rotary cutters 21A, 21B and 21C may be respectively driven separately by the three motors 25a, 25b and 25c. In the configuration shown in FIG. 4, the three motors 25a, 25b and 25c are installed on the upper side of the top plate 22 of the mower deck 20, but may be installed on the lower side of the top plate 22 of the mower deck 20.

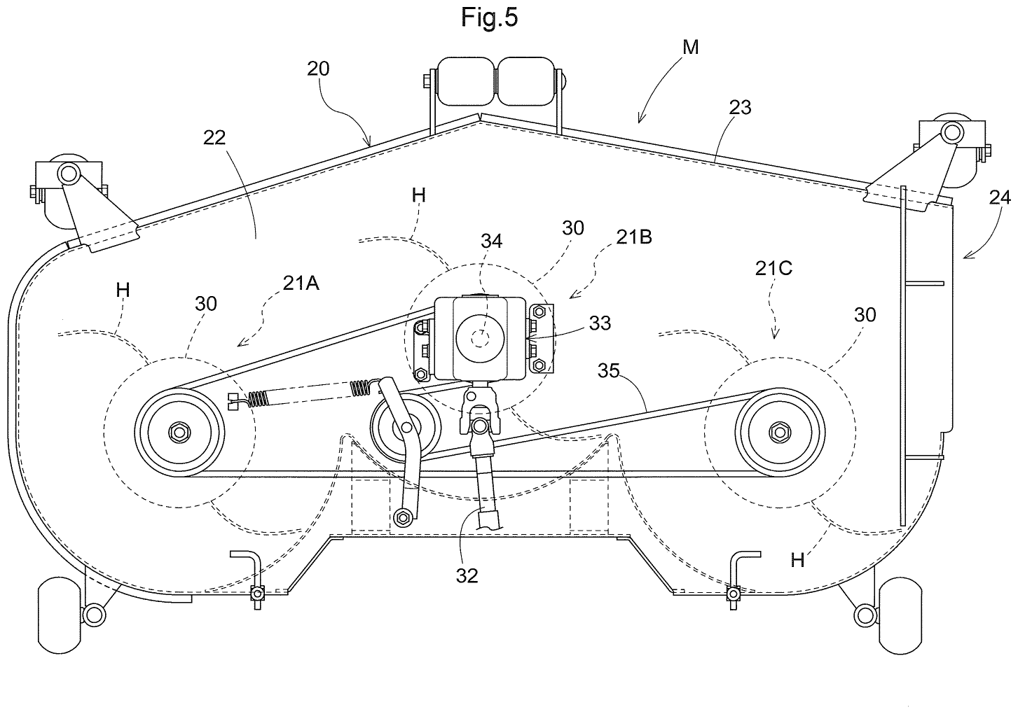

(2) In the above embodiment, the motive power of the work motor 25 about a vertical axis is transmitted to each of the rotary cutters 21A, 21B and 21C via the transmission belt 29. Alternatively, for example, as shown in FIG. 5, the motive power of the work motor 25 may be transmitted to a bevel gearbox 33 disposed in the middle of the upper surface of the mower deck 20 via a transmission shaft 32 extending in the front-back direction, and rotational power for rotation about a vertical axis that is converted by the bevel gearbox 33 may be transmitted to a rotary shaft 34 of the middle rotary cutter 21B, and further transmitted to the left and right rotary cutters 21A and 21C by a transmission belt 35.

(3) In the above embodiment, the three rotary cutters 21A, 21B and 21C are provided, but the number of rotary cutters is not limited to three, and one, two or four or more rotary cutters may be provided. In this case, the work motor 25 may be one motor or may be provided with a plurality of motors.

(4) In the above embodiment, each rotary cutter is provided with two string-like members H, but may be provided with only one string-like member H, or with three or more string-like members H. Also, the string-like member H is not limited to a nylon material, and may be another type of resin material.

(5) In the above embodiment, the travel electric motors 15 that drive the travel device 2 and the work electric motor 25 that drives the rotary cutters 21A, 21B and 21C are provided. Alternatively, one electric motor may be provided, and both the travel device 2 and the rotary cutters 21A, 21B and 21C may be driven by that electric motor. Also, drive is not limited to electric motors, and may be performed by an engine.

(6) The invention can be applied to a mower and a work machine equipped with a mower.

What is claimed is:

1. A mower mountable to a travel machine body, comprising:
a mower deck open downward; and
at least one rotary cutter located inside the mower deck and configured to rotate about a vertical axis, and
wherein the at least one rotary cutter is a string-like resin member.

2. The mower of claim 1, wherein:
the at least one rotary cutter comprises a plurality of rotary cutters spaced apart from each other inside the mower deck,
the mower deck comprises:
a top plate covering an upper portion thereof, and
a peripheral wall extending down along a peripheral edge of the top plate, and
the peripheral wall includes a back peripheral wall located on a back side thereof and having a wavy shape extending along rotation loci of outer edges of the rotary cutters.

3. The mower according to claim 1, wherein:
the at least one rotary cutter has a curved portion.

4. The mower according to claim 3, wherein:
the curved portion protrudes downstream in a rotation direction of the at least one rotary cutter.

5. A work machine comprising:
a travel machine body;
a travel device;
a mower mounted to the travel machine body, comprising:
a mower deck open downward; and
at least one rotary cutter located inside the mower deck and configured to rotate about a vertical axis;
a travel electric motor configured to drive the travel device; and
a work electric motor configured to rotationally drive the at least one rotary cutter, and
wherein the at least one rotary cutter is a string-like resin member.
